(19) United States
(12) Patent Application Publication
(10) Pub. No.: US 2026/0061704 A1
(43) Pub. Date: Mar. 5, 2026

(54) DEVICE AND METHOD FOR PRODUCING A THREE-DIMENSIONAL LAYERED OBJECT

(71) Applicant: DWS S.R.L., Thiene, Vicenza (IT)

(72) Inventor: Ettore Maurizio COSTABEBER, Thiene, Vicenza (IT)

(73) Assignee: DWS S.R.L., Thiene, Vicenza (IT)

(21) Appl. No.: 19/108,188

(22) PCT Filed: Sep. 1, 2023
(86) PCT No.: PCT/IB2023/058651

§ 371 Date: Mar. 3, 2025

(30) Foreign Application Priority Data
Sep. 2, 2022 (IT) 102022000018051

(51) Int. Cl. B29C 64/336; B29C 64/129; B29C 64/188; B29C 64/40; B33Y 10/00; B33Y 30/00; B33Y 40/00

(52) U.S. Cl. CPC B29C 64/336; B29C 64/129; B29C 64/188; B29C 64/40; B33Y 10/00; B33Y 30/00; B33Y 40/00

(57) ABSTRACT

The method for producing a three-dimensional layered object comprising the steps of: depositing, onto a support plane of a cooled platform, a first liquid which solidifies forming a first containing layer H1; depositing, onto the first containing layer H1, a second liquid which solidifies forming a first structural layer G2 of the three-dimensional object; the structural layer G2 is deposited in an area that has contours corresponding to the contours of a first section of the digital model of the three-dimensional object; forming a second containing layer H2 which completely surrounds the structural layer G2 in the directions X and Y; repeating the previous steps for all sections n of the three-dimensional model, thus producing an object formed by n superimposed structural layers G2, G3, . . . Gi, . . . Gn which is incorporated at the bottom and on the sides along the directions X and Y by n+1 containing layers H1, H2, . . . Hi, . . . Hn+1; melting the containing layers, hence freeing the three-dimensional layered object thus formed.

### CROSS-REFERENCE TO RELATED APPLICATIONS

This Patent Application claims priority from Italian Patent Application No. 102022000018051 filed on Sep. 2, 2022, the entire disclosure of which is incorporated herein by reference.

### TECHNICAL FIELD

The present invention refers to a device for producing a three-dimensional layered object and a method for producing a three-dimensional layered object.

### BACKGROUND OF THE INVENTION

The European patent EP 2 285 552 by the same inventor describes a method for the manufacture of a three-dimensional object formed by a plurality of superimposed layers of a liquid base photosensitive material at room temperature and capable of permanently solidifying following the action of electromagnetic radiation. The method described in the patent comprises the steps of: depositing the base material in a modelling platform arranged in a cooled chamber such that said base material reversibly solidifies forming a layer of solid material; selectively exposing the solid layer to the electromagnetic radiation in one or more predefined areas defined based on the section of a three-dimensional model of the object to be produced such that the base material irreversibly solidifies; and repeating the deposition and selective exposure operations for all sections of the model of the three-dimensional object.

At the end of these operations, an object is formed comprising a plurality of irreversibly solidified superimposed layers surrounded by reversibly solidified layers. Following the increase in temperature, the reversibly solidified layers go back to the liquid form, hence freeing the three-dimensional object.

The present invention aims to:
A. Limit the consumption of material for the production of the three-dimensional object;
B. Expand the range of applications using materials, also of the non-photosensitive type;
C. In the case of lost-wax micro-casting applications, use molten wax as the material of the three-dimensional object ;
D. Use, for producing the three-dimensional object, low-cost support material, easily available and guarantee total respect for the environment;
E. Ensure maximum precision and printing quality;
F. Ensure maximum printing homogeneity;
G. Ensure the release of the three-dimensional object without manual intervention of the operator; Ensure the release of the three-dimensional object without the use of solvents; and
H. Lower the operating costs.

### SUMMARY OF THE INVENTION

The above aim is achieved by the present invention in that it relates to a device of the type described in claim 1 and to a method described in claim 7.

### BRIEF DESCRIPTION OF THE DRAWINGS

The invention will be shown with reference to the accompanying drawings which represent a preferred non-limiting embodiment wherein:

FIG. 1 schematically shows a device realized according to the dictates of the present invention;

FIG. 2 shows a first step of the method according to the present invention;

FIG. 3 shows a second step of the method according to the present invention;

FIG. 4 shows a third of the method according to the present invention;

FIG. 5 shows a fourth step of the method according to the present invention;

FIG. 6 shows a fifth step of the method according to the present invention;

FIG. 7 shows a sixth step of the method according to the present invention;

FIG. 8 shows a seventh step of the method according to the present invention;

FIG. 9 shows an eighth step of the method according to the present invention;

FIGS. 10 and 11 show a step of repetition of the steps of FIGS. 2-9;

FIGS. 12, 13 and 14 show terminal steps of the method according to the present invention;

FIG. 15 shows a first variant to the method described in previous FIGS. 2-14; and

FIG. 16 shows a second variant to the method described in previous FIGS. 2-14.

### DESCRIPTION OF THE EMBODIMENT EXAMPLE

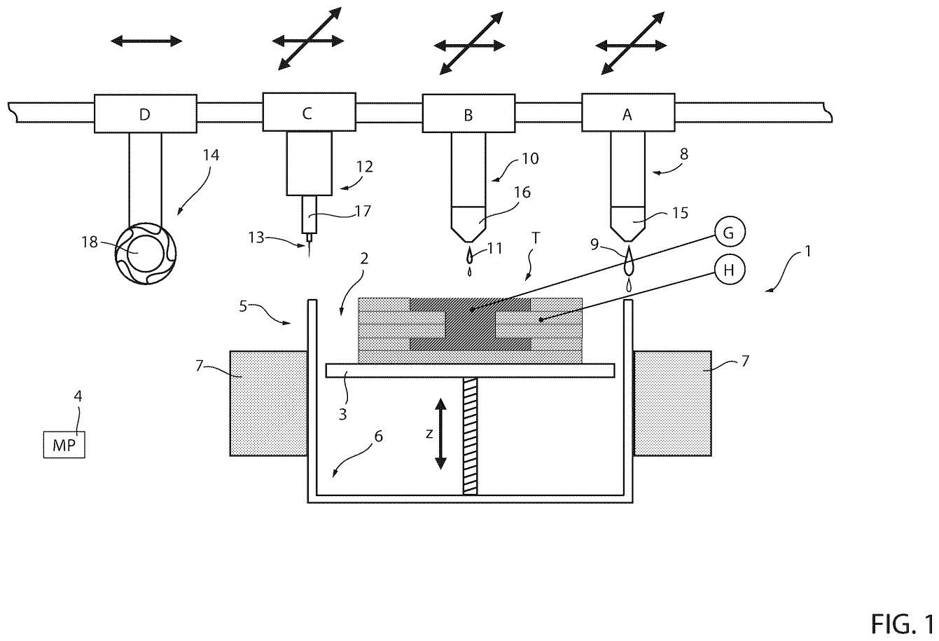

FIG. 1 schematically shows a device 1 for producing a three-dimensional layered object T.

The device 1 comprises a modelling platform 2 (schematically represented in the figures) on which the three-dimensional object T is formed; the modelling platform 2 is made with known technologies and comprises a support plane 3 movable along a direction Z with reversible linear motion due to the thrust of actuator means (not shown) in turn controlled by an electronic unit 4 (schematically shown).

Preferably, the direction Z is transverse, in particular orthogonal, to the support plane 3.

In other words, the support plane 3 is preferably horizontal, and the direction Z is preferably vertical.

The modelling platform is housed within a printing chamber 6.

More in detail, the modelling platform 2 is preferably housed in a modelling chamber 5 which internally defines the printing chamber 6, inside which the support plane 3 moves. The modelling chamber 5 is open at the top.

The device 1 further comprises at least one cooling device 7 (schematically represented) designed to cool the printing chamber 6 bringing to a predetermined temperature, preferably a temperature lower than 0° C.

Preferably, the cooling device 7 is associated with the modelling chamber 5.

Preferably, the electronic unit 4 is operatively connected to the cooling device 7, so as to be able to control, in use, the operation thereof.

In particular, the electronic unit 4 is preferably configured to be able to activate, on command, the cooling device 7 in such a way as to be able to bring the temperature inside the printing chamber 6 to said predetermined temperature, i.e. preferably below 0° C.

In addition, the electronic unit 4 is preferably configured to be able to deactivate, on command, the cooling device 7 so that the temperature inside the printing chamber 6 can exceed said predetermined temperature, i.e. so that the temperature inside the printing chamber 6 can increase and be brought to about room temperature (about in the neighbourhood of 20° C.).

Cooling devices of different type can be used, for example using a cooling liquid that is circulated in cavities (not shown) of the modelling chamber 5 or using Peltier cells (not shown).

The modelling platform 2 is also cooled as it is arranged inside the printing chamber 6. Additional cooling devices of the support plane 3 can also be used, for example Peltier cells (not shown).

In a position above the printing chamber 6 there are arranged:
a first selective deposition device 8 for a first liquid 9 designed to produce a support layer of the three-dimensional object;
a second selective deposition device 10 for a second liquid 11 designed to produce a structural layer of the three-dimensional object;
a selective irradiation device 12 designed to generate a thermal radiation 13 (e.g. a laser beam); and
a levelling device 14 for the previously deposited layers designed to treat the deposited layers to produce a surface parallel to a horizontal plane X-Y.

Preferably, the plane X_Y is transverse to the direction Z. In particular, the plane X_Y is advantageously orthogonal to the direction Z.

The above-mentioned devices are schematically shown; the first selective deposition device 8 comprises a first nozzle 15 movable in the plane X_Y relative to the modelling platform 2 and designed to dispense the first liquid 9 preferably in the form of droplets.

The second selective deposition device 10 comprises a second nozzle 16 movable in the plane X_Y relative to the modelling platform 2 and designed to dispense the second liquid 11 preferably in the form of droplets.

The selective irradiation device 12 comprises an end 17 from which the thermal radiation exits which can be provided both in punctiform concentrated form and in diffused form.

Preferably, the end 17 is also movable in the plane X_Y relative to the modelling platform 2.

Finally, the levelling device 17 comprises a movable milling cutter 18 which is also movable in the plane X_Y relative to the modelling platform 2.

The first liquid 9 has a melting temperature T1 such that it changes state passing from the liquid state to the solid state when it is dispensed onto the modelling platform by the nozzle 15 and the printing chamber 6 is cooled. Conveniently but not exclusively the first liquid is formed by water which solidifies at a melting temperature T1 lower than zero degrees centigrade (c) at the pressure of one atmosphere.

In other words, the melting temperature T1 is preferably higher than said predetermined temperature.

The second liquid 11 has a melting temperature T2 such that it changes state passing from the liquid state to the solid state when it is dispensed onto the modelling platform by the nozzle 15. Suitably but not exclusively the second liquid is molten wax which solidifies for a melting temperature lower than 60° C.-78° C. The melting temperature T2 is higher than the melting temperature T1 and is such that the second liquid remains solid at room temperature, i.e. at a temperature preferably ranging from 5°to 35°, and more advantageously around 20° C.

In other words, the melting temperature T2 is preferably higher than said predetermined temperature and is also preferably higher than the room temperature. Advantageously, the melting temperature T2 is higher than 20° C., and more in detail it is also higher than 35° C.

In use, the cooling devices 7 are activated by thermal conduction and bring the temperature of the printing chamber 6 and of the modelling platform 2 below the melting temperature T1 of the first liquid 9.

The steps of the method according to the present invention controlled by the electronic unit 4 will now be shown. The electronic unit 4 is provided with an internal memory in which a three-dimensional model of the three-dimensional layered object T to be produced is stored. Such a three-dimensional model comprises the coordinates of points defining the contours and the areas inside the contours of a plurality of successive sections of the three-dimensional object.

The method preferably provides for the step of bringing the temperature inside the printing chamber 6 to said predetermined temperature, i.e. preferably below 0° C.

More in detail, the method provides for the step of activating/operating the cooling device 7, in such a way as to bring the temperature inside the printing chamber 6 to said predetermined temperature, i.e. preferably below 0° C.

### First Step—Selective Deposition of the First Liquid and Formation of the Layer H1

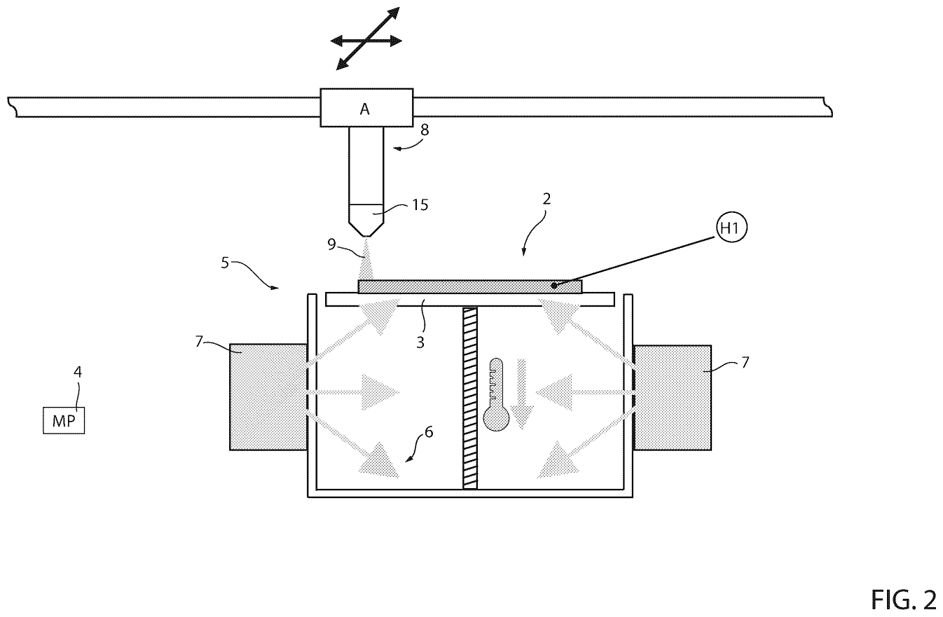

FIG. 2 shows a first step of the method according to the invention realized by the device 1.

The support plane 3 is arranged in an upper machining start position (Home position).

The first selective deposition device 8 moving in the plane X_Y due to the control of the electronic unit 4 deposits the liquid 9 onto the horizontal support plane 3 which immediately solidifies in contact with the support plane 3 forming a first containing layer H1. The first containing layer H1 defines an area which is greater than the area of the maximum section of the three-dimensional model defining the object to be produced.

### Second Step-Flattening of the First Layer H1

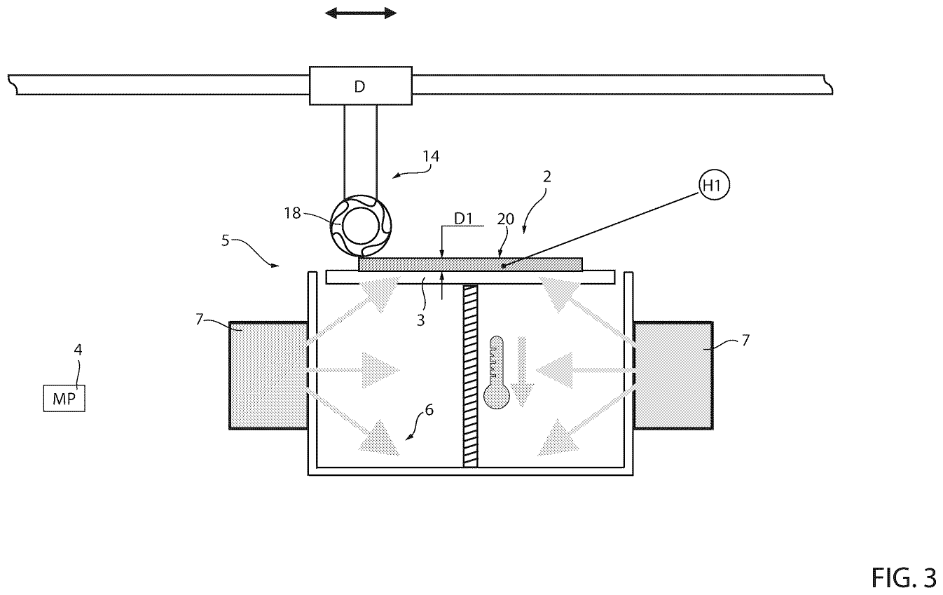

FIG. 3 shows a second step of the method according to the present invention.

The second step of the method according to the present invention preferably provides for the step of flattening, i.e. of shaping/levelling/grinding, advantageously by means of a material removal process, the face 20 of the first containing layer H1 facing in the opposite direction relative to the support plane 3, so that said face 20 is preferably flat and/or coplanar to the plane X_Y and/or parallel to the support plane 3.

More in detail, the levelling device 14 by moving the milling cutter 18 on the plane X_Y preferably performs the flattening/levelling of the face 20 of the first containment state H1 facing in the opposite direction relative the support plane 3, a first flat face 20 is thus created ensuring a constant thickness D1 of the first containing layer H1.

### Third Step-Lowering the Support Plane

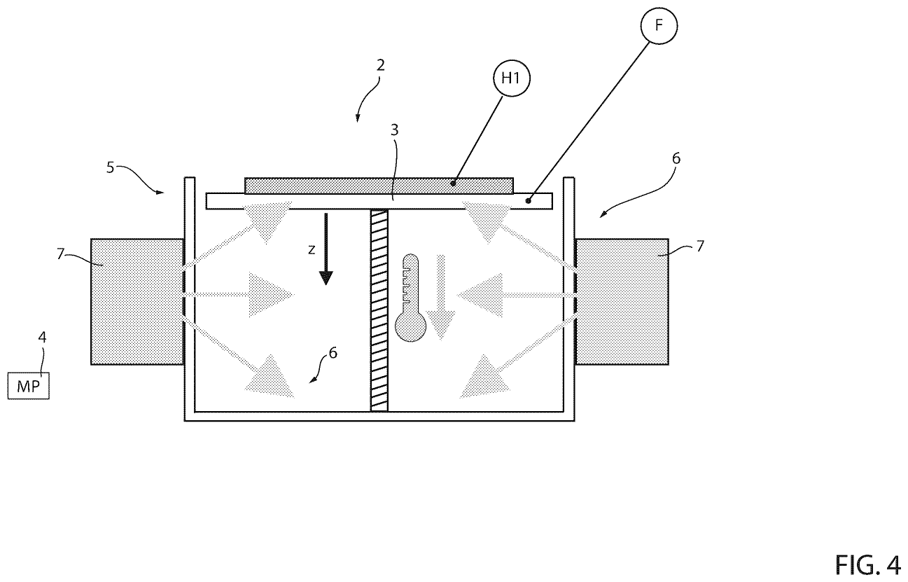

FIG. 4 shows a third step of the method according to the present invention.

The electronic unit 4 commands the modelling platform 2 so that the support plane 3 is moved along Z, i.e. preferably in a transverse direction and in particular orthogonal to the plane X_Y, and towards the bottom of the printing chamber 6 by a predetermined quantity, in particular a quantity equal to the thickness of the successive layer to be created. To optimize the printing time as a function of the surface quality of the final object, use is often made of the “variable layer thickness” technique, in which each layer could have a thickness different from the previous one.

### Fourth Step—Selective Deposition of the Second Liquid and Formation of the Layer G2.

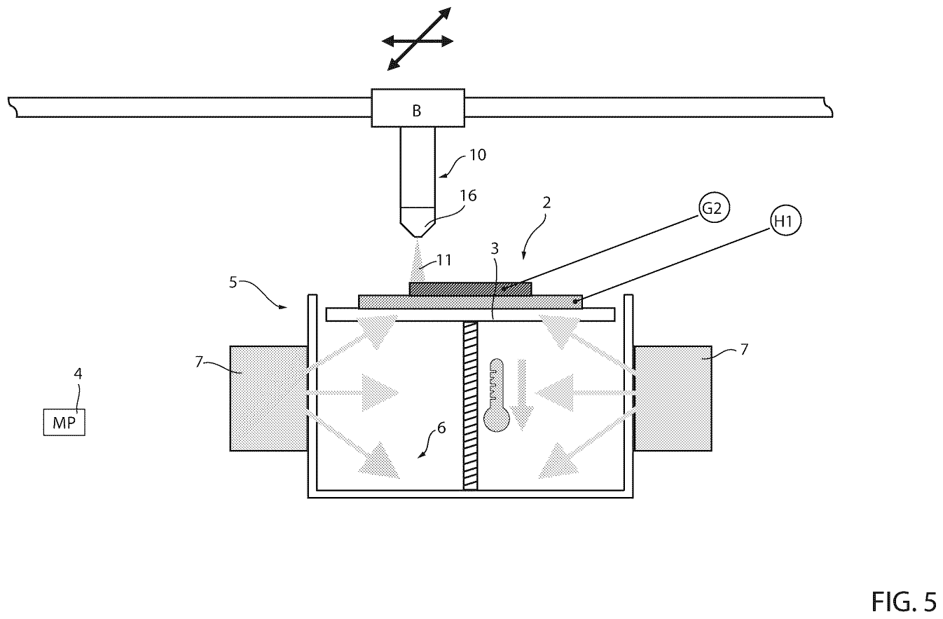

FIG. 5 shows a fourth step of the method according to the present invention.

The second selective deposition device 10 moving in the plane X_Y due to the control of the electronic unit 4 deposits, in particular selectively deposits, onto the first containing layer H1, which was previously formed, the second liquid 11 which immediately solidifies in contact with the first layer H1 forming a first structural layer G2 of the three-dimensional object having substantially constant thickness. The structural layer G2 is deposited in an area that has contours and area corresponding to the contours and to the area of a first section of the digital model of the three-dimensional object. As mentioned above, the three-dimensional model of the object to be produced is stored in the electronic unit 4.

The first structural layer G1 defines an area that is smaller than the area of the first containing layer H1 and is preferably arranged over a central portion of the first containing layer H1.

### Fifth Step—Melting of the Edges of the Layer G2

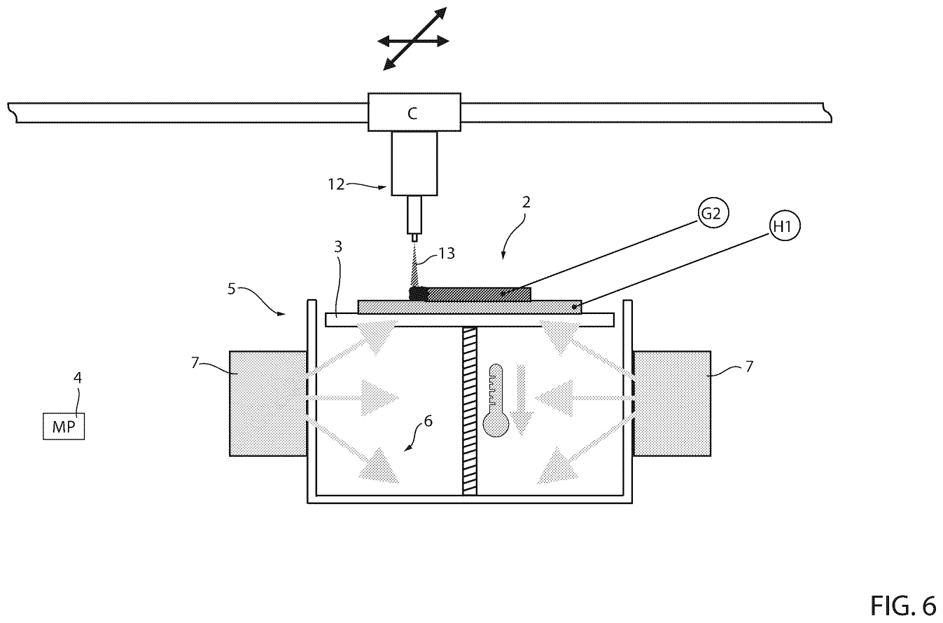

FIG. 6 shows an optional fifth step of the method according to the present invention.

The electronic unit 4 commands the movement of the selective irradiation device 12 so that the thermal radiation 13 leads to the melting of the side edges of the structural layer G2. The side edges of the structural layer G2 are perpendicular to the plane X_Y. This operation is useful if the second liquid 11 is made of molten wax. The wax, in fact, is emitted in tiny droplets which, when cooled, give an irregular wrinkled profile to the side edges of the structural layer G2. The melting and the subsequent solidification of the edges of the structural layer G2 contributes to reducing the granular character of the edges and that is to “flatten” these edges. Preferably, the melting is carried out in the area within the edges of the structural layer, so as to ensure homogeneity reducing the granular character. This non-mandatory option is used to ensure the homogeneity of the material within the model to be produced.

### Sixth Step—Selective Deposition of the First Liquid and Formation of the Layer H2.

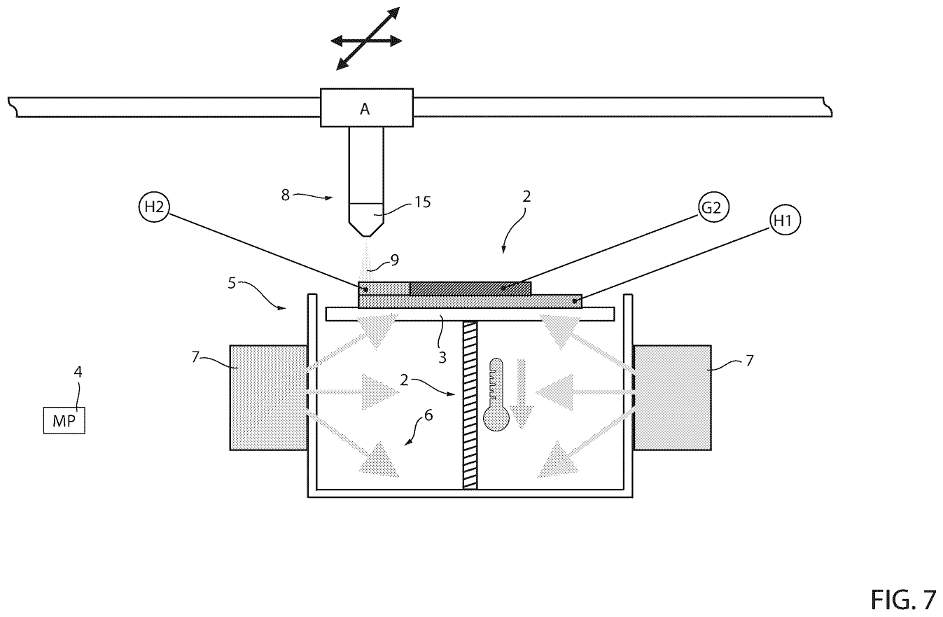

FIG. 7 shows a sixth step of the method according to the invention realized by the device 1.

The first selective deposition device 8 moving in the plane X_Y due to the control of the electronic unit 4 deposits, onto the containing layer H1 only in the zones that are not affected by the structural layer G2, the liquid 9 which immediately solidifies in contact with the layer H forming a second containing layer H2 which completely surrounds the structural layer G2 in the directions X and Y, i.e. advantageously parallel to the plane X_Y, and which has a substantially constant thickness and/or substantially equal to the thickness of the structural layer G2.

In other words, the directions X and Y are preferably transverse, in particular orthogonal, to the direction Z.

### Seventh Step—Flattening of the Layers G2 and H2

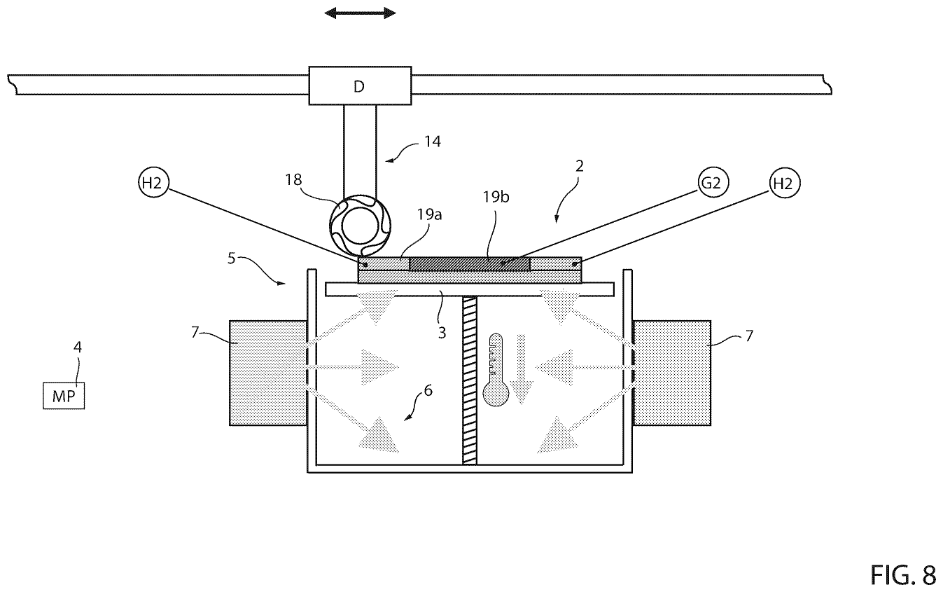

FIG. 8 shows a seventh step of the method according to the present invention.

The seventh step of the method according to the present invention preferably provides for the step of flattening, i.e. of shaping/levelling/grinding, advantageously by means of a material removal process, the face 19a of the second containing layer H2 and the face 19b of the structural layer G2 facing in the opposite direction relative to the support plane 3, so that said faces 19a and 19b are preferably flat and/or coplanar to the plane X_Y and/or parallel to the support plane 3.

More in detail, the levelling device 14 preferably, by moving the milling cutter 18 on the plane X_Y, performs the flattening/levelling of the face 19a of the second containing layer H2 facing in the opposite direction relative to the support plane 3 and the flattening of the face 19b of the structural layer G2 facing in the opposite direction relative to the support plane 3. These faces 19a and 19b are made coplanar and a constant thickness of the first structural layer G2 and of the second containing layer H2 is guaranteed. The deposited second layer may have a thickness different from that of the first layer.

### Eighth Step—Lowering The Support Plane

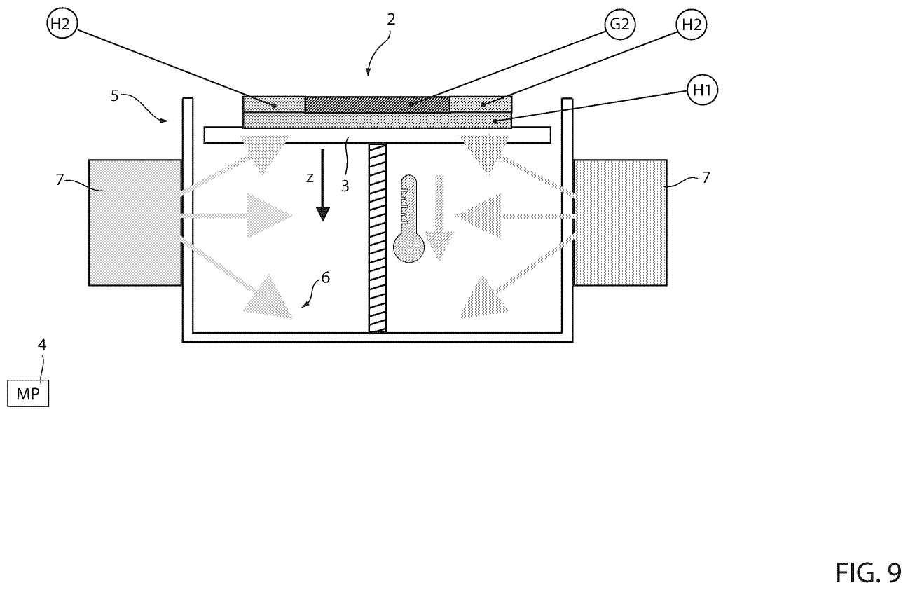

FIG. 9 shows an eighth step of the method according to the present invention.

The electronic unit 4 commands the modelling platform 2 so that the support plane 3 is again moved along Z, i.e. preferably in a transverse direction and in particular orthogonal to the plane X_Y, and towards the bottom of the printing chamber 6 by a predetermined quantity, in particular a quantity equal to the thickness of the successive layer to be created.

Iterative repetition of the fourth step, the fifth step, the seventh step and the eighth step.

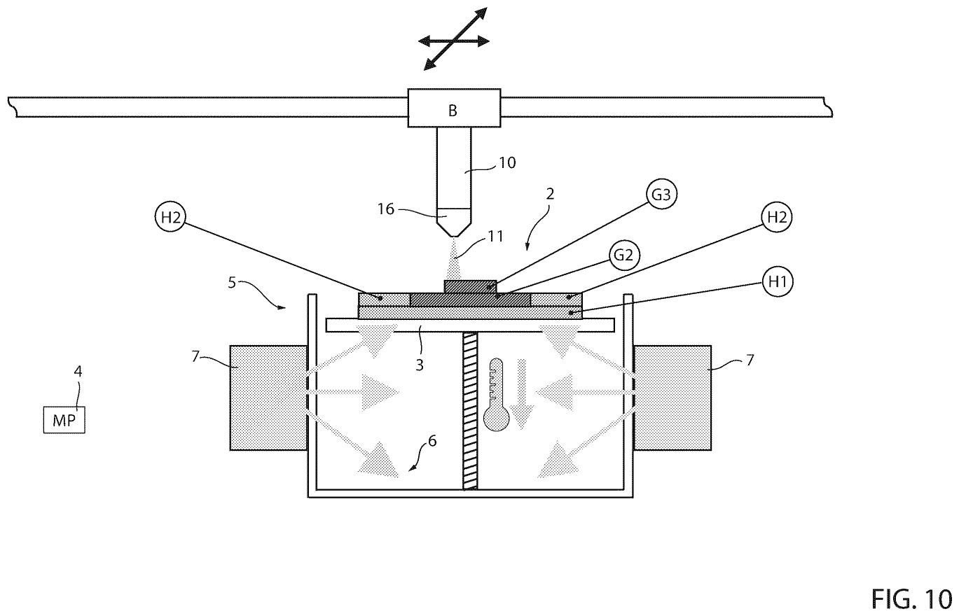

The fourth step is repeated for the deposition of the second liquid 11 and the formation of a structural layer G3 on top of the structural layer G2 (FIG. 10). The structural layer G3 is deposited in an area that has contours corresponding to the contours and to the area of a second section of the digital model of the three-dimensional object.

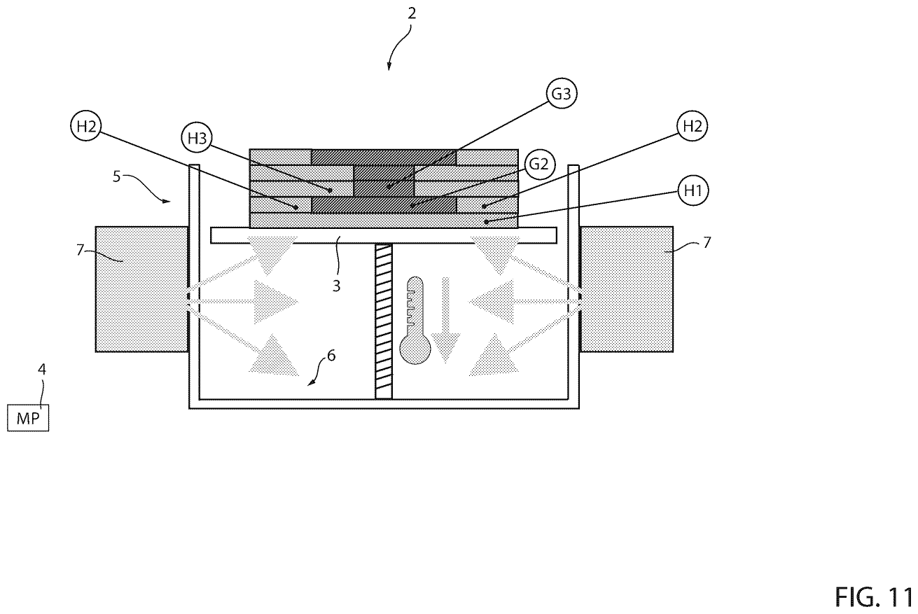

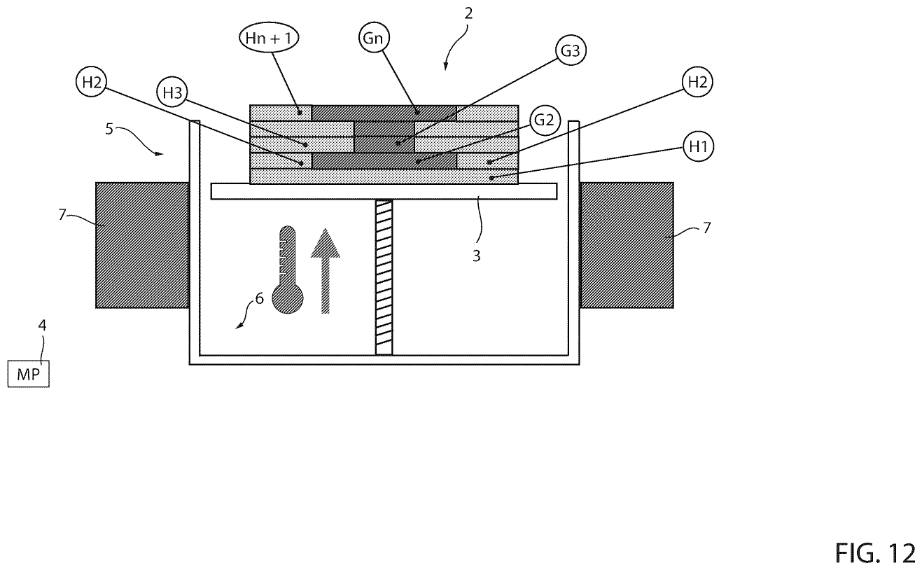

Subsequently, after a possible melting operation of the edges of the structural layer G3 or a possible melting of the entire structural layer G3, the sixth step is repeated in which the liquid 9 (FIG. 11), which immediately solidifies in contact with the containing layer H2/the underlying structural layer G2, is deposited onto the containing layer H2 and/or onto the structural layer G2 in the zones that are not affected by the layer G3. In this way, analogously to what is shown for the sixth step, a third containing layer H3 is created which completely surrounds the structural layer G3 in the directions X and Y, i.e. advantageously parallel to the plane X_Y, and which has a thickness substantially constant to the thickness of the layer G3. Subsequently, the layers G3 and H3 are machined and flattened with milling cutter 18 and made coplanar. Finally, the horizontal plane 3 is lowered.

The repetition of these steps for all sections n of the three-dimensional model allows to produce an object formed by n superimposed structural layers G2, G3, . . . , Gi, . . . Gn which is incorporated at the bottom and on the sides (i.e. along X and Y) by n+1 containing layers H1, H2, . . . Hi, . . . Hn+1.

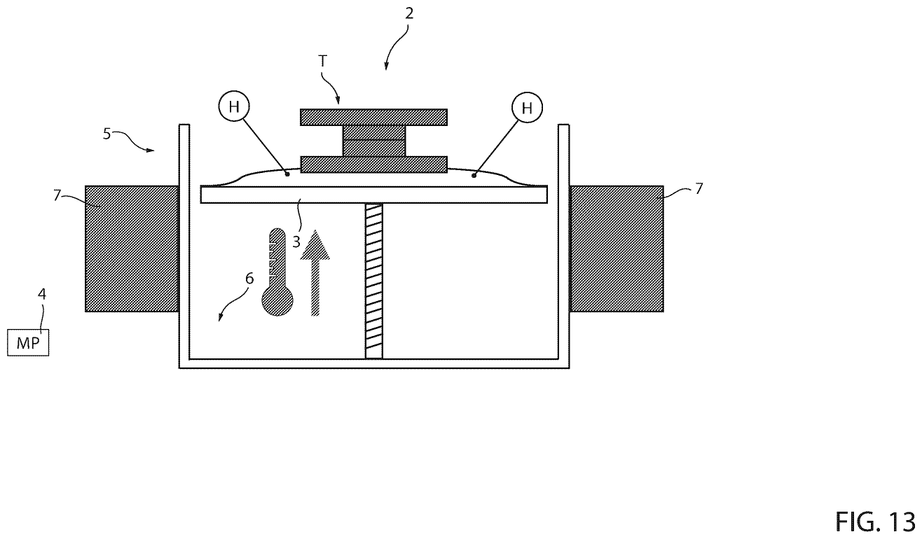

At the end of the completion of the iterations the cooling device 7 is deactivated (FIG. 13), so that the temperature of the chamber 6 increases and moves to that of the room (for example about 20° C.) exceeding the melting temperature T1, so that the containing layers naturally go back to the liquid state, hence freeing the three-dimensional layered object thus formed. At room temperature (e.g. about 20° C.) the second liquid remains in the solid state since the room temperature is lower than the melting temperature T2.

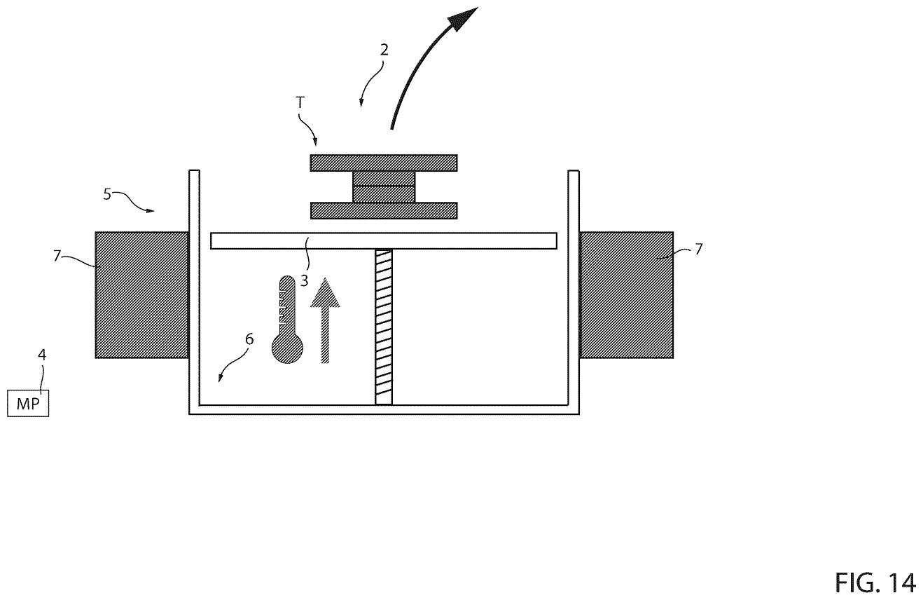

The formed three-dimensional object T can thus be taken from the modelling platform 2 (FIG. 14).

The following advantages are therefore achieved:
A. The deposition of the material of the object takes place selectively, limiting its consumption and consequently lowering the operating costs;
B. The material of the object can be of the non-photosensitive type, greatly expanding the range of the applications and lowering the operating costs;
C. In the case of lost-wax micro-casting applications, the material that forms the three-dimensional object can be molten wax, characterized by a lower melting temperature than a photosensitive resin, ensuring perfect compatibility with the heat treatment processes of these processes and consequently increasing the melting quality and lowering the operating costs;
D. The support material can be composed of water, significantly lowering the operating costs and ensuring total respect for the environment;
E. The flattening step at the end of the deposition of each layer guarantees maximum precision and printing quality in the direction of the axis Z;
F. The optional melting step of the edges of the layers Gn guarantees maximum precision and printing quality in the direction of the axes XY;
G. The optional melting step of the entire sections of the layers Gn guarantees maximum printing homogeneity in the direction of the axes XY;
H. The spontaneous melting of the support layers Hn by returning to room temperature guarantees the release of the three-dimensional object without manual intervention of the operator, avoiding possible damages to the three-dimensional object caused by the manipulation and by the detachment of the support structures;
I. The spontaneous melting of the support layers Hn by going back to room temperature guarantees the release of the three-dimensional object without the use of solvents, avoiding possible damages to the model caused by chemical action, consequently lowering its operating costs and guaranteeing total respect for the environment.

According to what is shown in the sixth step, the containing layer H2 is deposited only in the zones that are not affected by the structural layer G2.

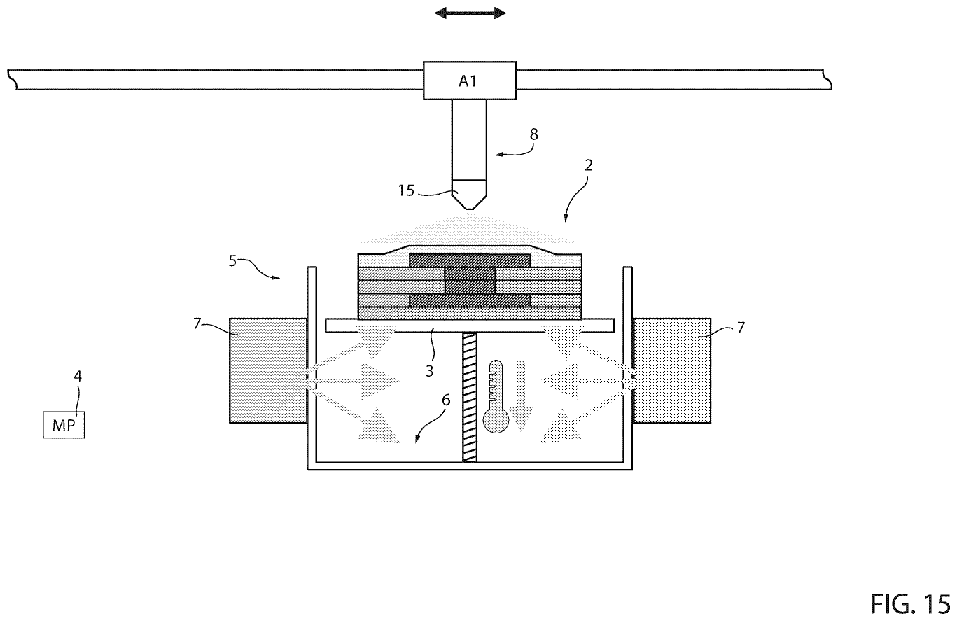

Alternatively, the containing layer H2 may be deposited (see FIG. 15) both on top of the structural layer and on top of the zones that are not affected by the structural layer. The subsequent flattening operation (seventh step) helps eliminate the first solidified liquid arranged on top of the structural layer.

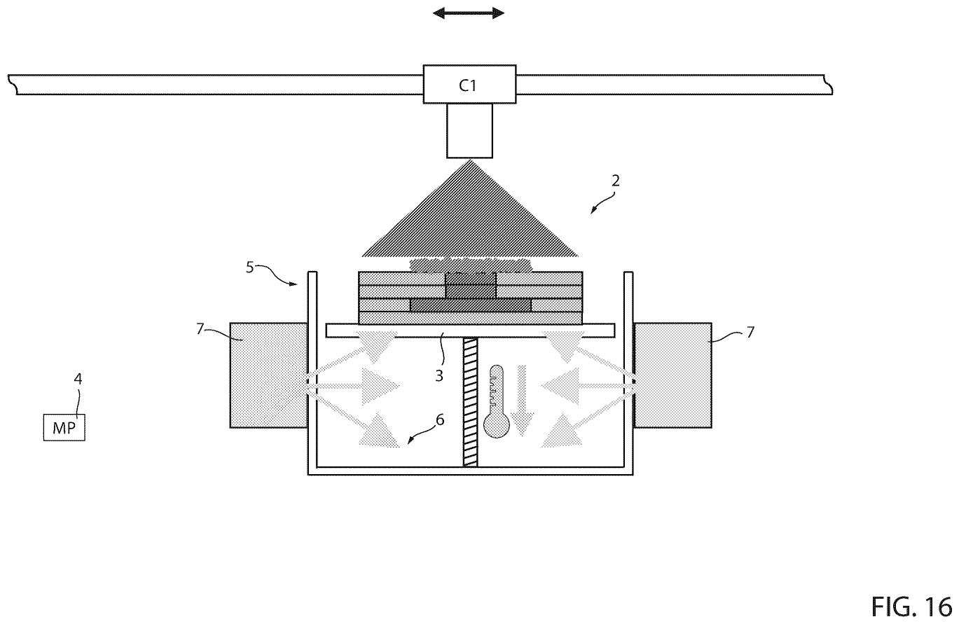

According to the alternative variant of FIG. 16, following the deposition operations of the fourth step, an even thermal irradiation of the previously deposited structural layer G2 is operated by means of the irradiation device—alternatively to what is shown in FIG. 6—in order to guarantee the homogeneity of the layer itself.

### NUMERALS

1 device for producing three-dimensional objects

2 modelling platform

3 horizontal support plane

4 electronic unit

5 modelling chamber

6 printing chamber

7 cooling device

8 first selective deposition device

9 first liquid

10 second selective deposition device

11 second liquid

12 selective irradiation device

13 thermal radiation

14 levelling device

15 first nozzle

16 second nozzle

17 end

18 milling cutter

19a, 19b faces

20 face

1. A device (1) for producing a three-dimensional layered object (T) wherein a modelling platform (2) defines a support plane (3) that is housed in a printing chamber (6);
the device (1) further comprising a cooling device (7) designed to cool the printing chamber (6);
the device (1) comprising:
a first selective deposition device (8) for a first liquid (9);
a second selective deposition device (10) for a second liquid (11);
the first liquid (9) has a melting temperature (T1) such that the first liquid (9) changes state passing from the liquid state to the solid state when it is dispensed onto the modelling platform (2) and the printing chamber (6) is cooled; the second liquid (11) has a melting temperature (T2) such that the second liquid (11) changes state passing from the liquid state to the solid state when it is dispensed onto the modelling platform; the melting temperature (T2) is greater than the melting temperature (T1);
the modelling platform (2), the first selective deposition device (8), the second selective deposition device (10) and the cooling device (7) are movable/operable due to the control of an electronic unit (4) so as to carry out the following steps:
a) depositing, onto the support plane (3), the first liquid (9) which immediately solidifies in contact with the support plane (3) forming a first containing layer (H1); the first containing layer (H1) defines an area which is greater than the area of the maximum section of the three-dimensional model defining the three-dimensional layered object (T) to be produced;
b) flattening the face (20) of the first containment layer (H1) facing in the opposite direction relative to the support plane (3) thus creating a first flat face (20) coplanar to a plane (X_Y) ensuring a constant thickness (D1) of the first containing layer (H1);
c) depositing, onto the first containing layer (H1), which was previously formed, the second liquid (11) which immediately solidifies in contact with the first containing layer (H1) forming a first structural layer (G2) of the three-dimensional layered object (T); the first structural layer (G2) is deposited in an area that has contours corresponding to the contours of a first section of the digital model of the three-dimensional layered object (T);
d) depositing, onto the first containing layer (H1), at least in the zones that are not affected by the first structural layer (G2) the first liquid (9), which immediately solidifies in contact with the first containing layer (H) forming a second containing layer (H2), which completely surrounds the first structural layer (G2) in the directions X and Y;
e) flattening the face (19a) of the second containing layer (H2) facing in the opposite direction relative to the support plane (3) and the face (19b) of the first structural layer (G2) facing in the opposite direction relative to the support plane (3), thus making said faces coplanar and ensuring a constant thickness of the first structural layer (G2) and of the second containing layer (H2);
f) repeating steps c), d) and e) for all sections n of the three-dimensional model, thus producing an object formed by n superimposed structural layers (G2, G3, . . . Gi, . . . Gn) which is incorporated at the bottom and on the sides along the directions X and Y by n+1 containing layers (H1, H2, . . . Hi, . . . Hn+1);
deactivating the cooling device (7) so that the temperature of the printing chamber (6) exceeds the melting temperature T1 and the containing layers (H1, H2, . . . Hi, . . . Hn+1) naturally go back to the liquid state, hence freeing the three-dimensional layered object (T) thus formed.

2. The device according to claim 1, wherein the support plane (3) is movable along a direction (Z) transverse, in particular orthogonal, to said plane (X_Y); said device (1) further comprising an electronic unit (4) configured to control the movement of said support plane (3);
said electronic unit (4) being configured to, following step b) and step e), command a displacement of the support plane (3) relative to the printing chamber (6) by a predetermined quantity.

3. The device according to claim 1, wherein the device further comprises a selective irradiation device (12) designed to generate a thermal radiation (13) used for the selective irradiation of the second liquid (11); the electronic unit (4) is configured to command the movement of the selective irradiation device (12) following step c) so that the thermal radiation (13) leads to the melting of the side edges of the corresponding structural layer (G2, G3, . . . Gi, . . . Gn); the side edges of the corresponding structural layer (G2, G3, . . . Gi, . . . Gn) are perpendicular to the plane (X_Y); this operation leads to the melting of the edges which subsequently solidify, decreasing the granular character of the edges themselves.

4. The device according to claim 1, wherein the device (1) further comprises a selective irradiation device (12) designed to generate a thermal radiation (13) and to operate an even thermal irradiation of the structural layer (G2, G3, . . . Gi, . . . Gn), which was previously deposited.

5. The device according to claim 1, wherein in said step d) the second containing layer (H2) is only deposited in the zones that are not affected by the first structural layer (G2).

6. The device according to claim 1, any wherein the second containing layer (H2) is deposited both on top of the first structural layer (G2) and on top of the zones that are not affected by the first structural layer (G2); the following step e) contributes to eliminate the solidified first liquid arranged on top of the structural layer (G2).

7. A method for producing a three-dimensional layered object (T) through deposition of a first liquid (9) and of a second liquid (11); the first liquid (9) has a first melting temperature (T1) such that the first liquid changes state passing from the liquid state to the solid state when it is dispensed onto a modelling platform (2) arranged in a coolable printing chamber (6); the second liquid (11) has a second melting temperature (T2) such that the second liquid changes state passing from the liquid state to the solid state when it is dispensed onto the modelling platform (2); the second melting temperature (T2) is higher than the first melting temperature (T1);
the method comprising the following steps:
a) depositing, onto a support plane (3) of the modelling platform (2), the first liquid (9) which immediately solidifies in contact with the support plane (3) forming a first containing layer (H1); the first containing layer (H1) defines an area that is greater than the area of the maximum section of the three-dimensional model defining the three-dimensional layered object (T) to be produced;
b) flattening the face (20) of the first containment layer (H1) facing in the opposite direction relative to the support plane (3) thus creating a first flat face (20) coplanar to a plane (X_Y) ensuring a constant thickness (D1) of the first containing layer (H1);
c) depositing, onto the first containing layer (H1), which was previously formed, the second liquid (11) which immediately solidifies in contact with the first containing layer (H1) forming a first structural layer (G2) of the three-dimensional layered object (T); the first structural layer (G2) is deposited in an area that has contours corresponding to the contours of a first section of the digital model of the three-dimensional layered object (T);
d) depositing, onto the first containing layer (H1), at least in the zones that are not affected by the first structural layer (G2) the first liquid (9), which immediately solidifies in contact with the first containing layer (H) forming a second containing layer (H2), which completely surrounds the first structural layer (G2) in the directions X and Y;
e) flattening the face (19a) of the second containing layer (H2) facing in the opposite direction relative to the support plane (3) and the face (19b) of the first structural layer (G2) facing in the opposite direction relative to the support plane (3), thus making said faces coplanar and ensuring a constant thickness of the first structural layer (G2) and of the second containing layer (H2);
f) repeating steps c), d) and e) for all sections n of the three-dimensional model, thus producing an object formed by n superimposed structural layers (G2, G3, . . . Gi, . . . Gn) which is incorporated at the bottom and on the sides along the directions X and Y by n+1 containing layers (H1, H2, . . . Hi, . . . Hn+1);
g) changing the temperature of the printing chamber (6) so that said temperature exceeds the first melting temperature (T1) and the containing layers (H1, H2, . . . Hi, . . . Hn+1) naturally go back to the liquid state, hence freeing the three-dimensional layered object (T) thus formed.

8. The method according to claim 7, wherein following step b) and step e), the support plane (3) is moved relative to the printing chamber (6) by a predetermined quantity.

9. The method according to claim 7, wherein, following step c), a thermal radiation (13) is directed towards the side edges of the corresponding structural layer (G2, G3, . . . Gi, . . . Gn); the side edges of the corresponding structural layer (G2, G3, . . . Gi, . . . Gn) are perpendicular to the plane (X_Y); this thermal radiation (13) leads to the melting of the edges which subsequently solidify, decreasing the granular character of the edges themselves.

10. The method according to claim 7, wherein an even thermal irradiation (13) of the structural layer (G2, G3, . . . Gi, . . . Gn), which was previously deposited, is applied.

11. The method according to claim 7, wherein in said step d) the second containing layer (H2) is only deposited in the zones that are not affected by the first structural layer (G2).

12. The method according to claim 7, wherein the second containing layer (H2) is deposited both on top of the first structural layer (G2) and on top of the zones that are not affected by the first structural layer (G2); the following step e)
Contributes to eliminate the solidified first liquid (9) arranged on top of the second structural layer (G2).
